(19) United States
(12) Patent Application Publication
(10) Pub. No.: US 2009/0324211 A1
(43) Pub. Date: Dec. 31, 2009

(54) Method and Device for Geo-Tagging an Object Before or After Creation

(75) Inventors: Toni Peter Strandell, Helsinki (FI); James Francis Reilly, Helsinki (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/146,191

(22) Filed: Jun. 25, 2008

(51) Int. Cl. G03B 17/24

(52) U.S. Cl. 396/310; 455/456.1

(57) ABSTRACT

In accordance with an example embodiment of the present invention, a process communicates with a location source to obtain location information. The process determines a location of an object at a time other than creation of the object based on the location information. The process associates the determined location with the object.

### RELATED APPLICATIONS

This application relates to U.S. patent application Ser. No. 12/116,699, titled “GEO-TAGGING OBJECTS WITH WIRELESS POSITIONING INFORMATION”, filed May 7, 2008 and PCT International Application No.: PCT/IB2007/003164 titled “Distance Estimation”, filed Aug. 7, 2007, which are hereby incorporated by reference in their entirety.

### TECHNICAL FIELD

The present application relates generally to geo-tagging an object before or after creation.

### BACKGROUND

Electronic devices are commonly equipped with digital cameras to enable taking still photographs or motion pictures and transmitting the captured digital images thereof over a cellular network. More elaborate electronic devices with digital cameras are also available with Global Positioning System (GPS) sensors to enable identifying the geographic location of the phone at the time the photograph is taken, a technique called geo-tagging the photograph. Geo-tagging techniques, however, are still limited.

### SUMMARY

In accordance with an example embodiment of the present invention, a process communicates with a location source to obtain location information. The process determines a location of an object at a time other than creation of the object based on the location information. The process associates the determined location with the object.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1A is a block diagram of an electronic device comprising a digital camera module and being in communication with a location source according to an example embodiment of the invention;

FIG. 1B is a block diagram of the electronic device of FIG. 1A depicting the digital camera module in more detail and communications, via wireless transceivers, to location sources according to an example embodiment of the invention;

FIG. 1C is a block diagram of the electronic device of FIG. 1A communicating, via wireless transceivers, with a remote location source in accordance with an example embodiment of the invention;

FIG. 2 is a flow diagram illustrating a process geo-tagging an object after creation by applying rules according to an example embodiment of the invention;

FIG. 3 is a flow diagram illustrating a process for associating a location with an object after creation according to an example embodiment of the invention; and

FIG. 4 is a flow diagram illustrating a process for associating a location with an object before creation according to an example embodiment of the invention.

### DETAILED DESCRIPTION OF THE DRAWINGS

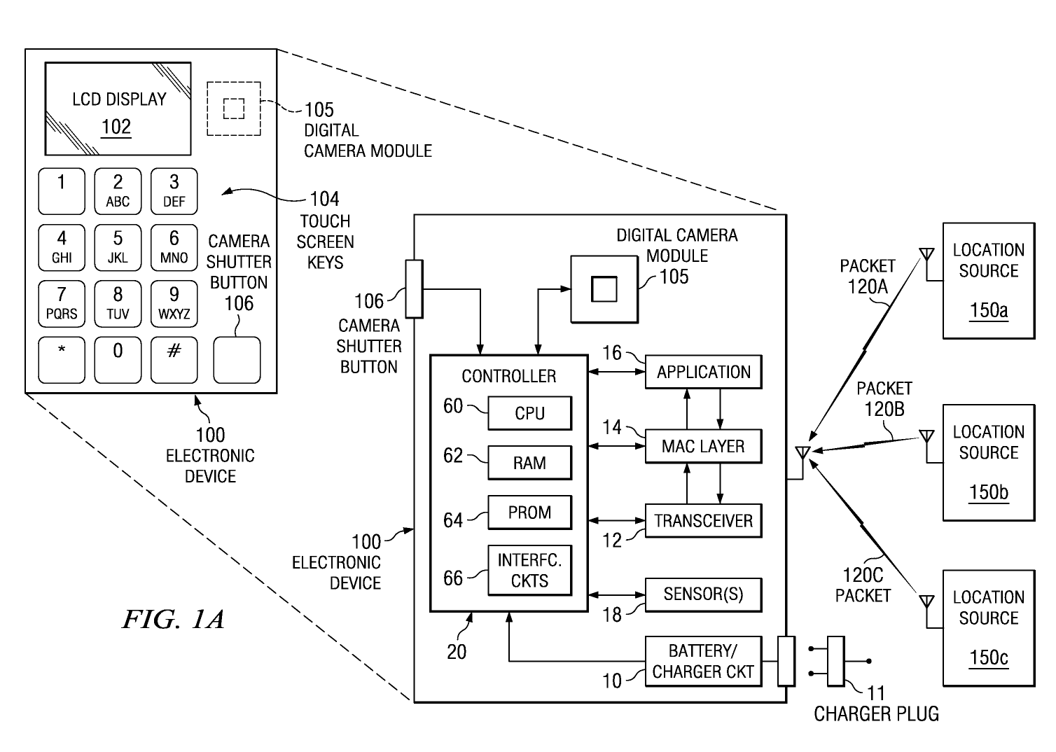

An example embodiment of the present invention and its potential advantages are best understood by referring to FIGS. 1A through 4 of the drawings.

FIG. 1A is a block diagram of an electronic device 100 comprising a digital camera module 105 and being in communication with a location source, such as location sources 150a-c, according to an example embodiment of the invention. The electronic device 100 may be a mobile communications device, personal digital assistant (PDA), cell phone, pager, laptop computer, palmtop computer, or the like. In an embodiment, the electronic device 100 may also be part of another device. For example, electronic device 100 may be an integrated component of a vehicle, such as an automobile, bicycle, airplane, other mobile conveyance and/or the like.

In an example embodiment, the electronic device 100 comprises a controller module 20, which comprises a processor or central processing unit (CPU) 60, a Random Access Memory (RAM) 62, a Read Only Memory (ROM) or programmable read only memory (PROM) 64, and interface circuits 66 to interface with a key pad 104, a liquid crystal display (LCD) 102, and the digital camera module 105. In an embodiment, the electronic device 100 may optionally include a microphone, speakers, ear pieces, a video camera, or other imaging devices. In an embodiment, the RAM 62 and PROM 64 may be removable memory devices such as smart cards, Subscriber Identity Modules (SIMs), Wireless Application Protocol Identity Modules (WIMs), semiconductor memories such as a RAM, ROM, or PROM, flash memory devices, or the like. In another embodiment, the RAM 62 may be volatile memory and the PROM 64 may be non-volatile memory. Other variations are also possible.

In an embodiment, a Medium Access Control (MAC) Layer 14 of the electronic device 100 and/or application program 16 may be embodied as program logic stored in the RAM 62 and/or PROM 64 in the form of sequences of programmed instructions which may be executed in the processor 60, to carry out the techniques of example embodiments. For example, the program logic may be delivered to the writeable RAM 62, PROM 64, flash memory device, or the like of the electronic device 100 from a computer program product or article of manufacture in the form of computer-usable media, such as resident memory devices, smart cards or other removable memory devices, or in the form of program logic transmitted over any transmitting medium which transmits such a program. Alternately, the MAC Layer 14 and/or application program 16 may be embodied as integrated circuit logic in the form of programmed logic arrays or custom designed Application Specific Integrated Circuits (ASIC). The transceiver 12 in the electronic device 100 operates in accordance with network protocols of the electronic device 100 using packets 120A-C.

In an example embodiment, the processor 60 tags and/or geo-tags an object at a time other than creation by associating a location to the object, e.g., a video, media object, audio file, Short Message Service, and/or the like. For example, a wireless transceiver 12 communicates with a location source 150, such as location sources 150a-c, on the same network platform, such as the same network service, server, and/or the like, as the object/electronic device 100 to obtain location information. In an embodiment, the location sources 150a-c may be a device, server, service, Internet application, and/or the like. For example, the wireless transceiver 12 communicates with a second electronic device, e.g., location source 150a, which is tracking location information on the same network platform as the electronic device 100. The processor 60 may apply one or more rules, as described below, to determine a location from the location information of the second electronic device. The processor 60 may associate the determined location to the object either before or after creation. In this way, the processor 60 may determine a location or positional/geographic meta data for an object using user-definable rules. The processor 60 tags or geo-tags the object with the location. It should be understood that any number of location sources may be used to employ example embodiments of the invention.

In an embodiment, geo-tagging may refer to the process of adding geographical identification metadata to an object, such as latitude and longitude coordinates, so that these files may later be referenced, searched, and grouped based on origin. It should be further understood that the object may also include the following meta data format types for geo tagging the International Press Telecommunications Council, IPTC, standard, Extensible Metadata Platform, XMP, NewsML, Universal Transverse Mercator Projection, UTM, National Grid, Irish Grid and/or the like. It should be understood that associating may include embedding or tagging metadata in the object, or otherwise providing a unique association between the metadata and the object, e.g., by storing a pointer in the object pointing to the associated metadata.

In an example embodiment, the processor 60 may recognize the presence of a known device, such as the second electronic device described above. The processor 60, for example, may recognize a device from a Bluetooth device address stored as meta data in the object, facial recognition identifying a person in the object, e.g., known person with known device, ambient sound analysis identifying people speaking within a period of time from the object creation/capturing time, and/or the like. The transceiver 12 communicates, using a Bluetooth device address, for example, with the second electronic device and the processor 60 determines a location or geographic position at a time other than the creation time of the object. In an embodiment, the transceiver 12 may communicate with the second electronic device using a bluetooth device addresses or the like. It should be understood that the example embodiments of the invention may use any number of different devices and is not limited to Bluetooth devices.

In another example embodiment, the processor 60 may determine a location using a published photograph including metadata, a set of Bluetooth address for nearby devices, and GPS information, such as coordinates, cell id, and country/city/street name. The processor 60 may use, for example, the Bluetooth address to identify other objects captured in a similar time period/window as the object. The processor 60 may identify other objects by comparing a plurality of remote timestamps and remote metadata, associated with a location, to a local timestamp and local metadata. For example, the remote metadata may include a device identifier of 1234, at location of x, and timestamp of t. Further, the local object may include a device identifier of 1234 and a timestamp of t. By matching the device identifiers and timestamp, the processor 60 may determine the location of the object as x.

In yet another embodiment, the processor 60 may use a service, which comprises a user's location at the time of the object's creation/capture time. One such service may be Nokia Sports Tracker. Nokia Sports Tracker, for example, is a GPS-based activity tracker that runs on electronic devices, such as electronic device 100. Information, such as speed, distance, location, e.g., GPS information/latitude, longitude, and a time period, may be automatically stored in a log. By accessing the log, the processor 60 may determine a location for the object by comparing or otherwise matching the object creation/capture time with a time within the closet log time period. For example, the log time is within the time period/time window set. In an embodiment, the processor 60 associates, e.g., geo-tags, to the object. It is useful to note that since location does not originate from the electronic device 100, but rather from the log, the processor 60 may geo-tag objects for non-mobile cameras and mobile cameras with or without GPS capabilities.

It should be understood that since there are any number of possible location sources a-c 150a-c, there are many possible meta data formats the processor 60 may use for geo-tagging. In an example embodiment, the location sources a-c 150 a-c may comprise location information in a format, such as the Exchangeable Image Format (EXIF) or International Press Telecommunications Council (IPTC). These formats allow many types of name/value attributes to be added to image objects. Further, object repositories may allow objects to have textual tags associated to them, for example when they are published on the Internet or edited later. Geographic tags, such at latitude and longitude, are attached as tags known as “geo tagging.” In an embodiment, Geo-tagging may refer to the process of adding geographical identification metadata to an object, such as latitude and longitude coordinates, so that these files may later be referenced, searched, and grouped based on origin. It should be further understood that the object may also include the following meta data format types for geo tagging the International Press Telecommunications Council, IPTC, standard, Extensible Metadata Platform, XMP, NewsML, Universal Transverse Mercator Projection, UTM, National Grid, Irish Grid and/or the like.

Other components that may be included in the electronic device 100 include sensors 18, which may detect changes in the inertial frame of reference of the electronic device 100, to enable damping vibrations that might impair the quality of the photographs taken by the digital camera module 105. The battery charging circuit 10 and charger plug 11 may replenish the charge in rechargeable batteries used by the electronic device 100.

FIG. 1B is a block diagram of the electronic device 100 of FIG. 1A, showing the digital camera module 105 in more detail, the display 102, and communications via wireless transceivers 12 and 12′ according to an example embodiment of the invention. For example, the transceivers 12 and 12′ include both a transmitter and a receiver for operating over the wireless network protocol. In an embodiment, transceiver 12 may operate using a Wireless Wide Area Network (WWAN) protocol operating, for example, under a cellular telephone network protocol, and transceiver 12′ may operate using a wireless local area network (WLAN) protocol or a Wireless Personal Area Network (WPAN) protocol. Use of other protocols is also possible.

In an example embodiment, the electronic device 100 comprises the digital camera module 105, which comprises a lens 68, an electric shutter 69, a CMOS sensor 70, and an analog to digital converter (ADC) 72. The lens 68 converge incident light on the CMOS sensor 70. The electric shutter 69 may be an electromechanical or electro-optical shutter that is opaque to the incident light until actuated by the shutter button 106. The CMOS sensor 70 may be an RGB color filter that converts incident light into electric signals representing red, green, and blue light components. Objects or images are created/captured by actuating the shutter button 106 to open the electric shutter 69, which exposes the CMOS sensor 70 to incident light refracted through the lens 68. The electric signals representing red, green, and blue light output by the CMOS sensor 70 are converted to digital image or object signals by the analog to digital converter 72 and output to the controller 20. The image sensor 70 may comprise a different type of sensor, such as a Charge Coupled Device (CCD). The digital camera module 105 may be mounted anywhere on the electronic device 100, for example on the front side of the electronic device 100 or connected to the electronic device 100 via a cable, Bluetooth, or other Wireless Personal Area Network (WPAN) link.

In an embodiment, the controller 20 may further process the object or object signals from an analog to digital converter 72, forming an object file by compressing the digital image using the Joint Photographic Experts Group (JPEG) compression algorithm, or other compression algorithm, and performing other image processing operations on the object file before storing the object file in the RAM 62. In an embodiment, the digital camera module 105 may also record motion pictures by periodically capturing a sequence of digital images, for example at thirty images per second, and the controller 20 may further process the sequence as compressed JPEG files or Moving Picture Experts Group (MPEG) files or in another format and store them in the RAM 62. It should be understood that examples embodiments of the invention are application to any number of objects, such as video, audio, SMS, and/or the like.

In an example embodiment, the electronic device 100 and the location source 150 may communicate in a wireless network that may be a wireless personal area network (WPAN) operating, for example, under the Bluetooth or IEEE 802.15 network protocol. For example, the wireless network may be a wireless local area network (WLAN) operating, for example under the IEEE 802.11, Hiperlan, WiMedia Ultra Wide Band (UWB), WiMax, WiFi, Digital Enhanced Cordless Telecommunications (DECT) network protocol, and/or the like. Or, the wireless network may be a wireless wide area network (WWAN) operating, for example, under a cellular telephone network protocol, for example Global System for Mobile (GSM), General Packet Radio Service (GPRS), Enhanced Data rates for GSM Evolution (EDGE), Code Division Multiple Access (CDMA), Universal Mobile Telecommunications System (UMTS) CDMA2000, and/or the like. The respective wireless network protocols include provision for communication by the electronic device 100 in the network with the location source by way of a Protocol Data unit (PDU) packet, such as Packets 120A-C of FIG. 1A. These examples of wireless network protocols for the electronic device 100 are not meant to be limiting, since it is common for wireless communications protocols to provide for communication between electronic devices and a wired network infrastructure.

Each of these example networks is defined by communications protocol to include the exchange of packets of data and control information between the location source, such as location sources 150a-c, and the electronic device 100. In an embodiment, the communications protocol may define levels of networking functions and the services performed at each level for the location source and the electronic device 100 operating using the protocol. In an embodiment, the networking techniques may comprise a transmission of packets by the location source to announce presence of the electronic device within range, either by initiating an inquiry or beacon packet or by responding with a response packet to a probe packet from the electronic device 100.

The mobile wireless device 100 of FIG. 1B may optionally have two or more wireless transceivers 12 and 12′ communicating with a location source, such as location sources a-c 150a-c to obtain location information. In operation, one of the transceivers 12 may be, for example, a cellular telephone transceiver operating under example network protocols such as GSM, GPRS, EDGE, CDMA, UMTS, CDMA2000, and/or the like. The second transceiver 12′ may be, for example, a wireless LAN transceiver operating under example network protocols such as IEEE 802.11, Hiperlan, WiMedia UWB, WiMax, WiFi, DECT, and/or the like. Optionally, a third transceiver may be included in the electronic device 100, operating under a personal area network protocol, such as the Bluetooth or IEEE 802.15 protocols.

FIG. 1C is a block diagram of the electronic device 100 of FIG. 1A communicating, via wireless transceivers 12 and 12′, with a remote location source 117 in accordance with an example embodiment of the invention. In an example embodiment, the processor 60 geo-tags a local object at a time other than creation by associating a location, remote time, and/or remote metadata with a local time and local metadata using a remote location source. In an embodiment, a wireless transceiver 12 communicates with a remote location source 117 to obtain the remote location information. In an embodiment, the remote location information may comprise a location, remote time, remote metadata, and/or the like. For example, the remote location source 117 may include a device identifier of 1234, at location of x, and time of t, e.g. from creation of the remote item. The local object comprises a device identifier of 1234 and a time of t. Thus, the processor 60 may determine a location by matching the remote device identifier and time with the device identifier and time of the local object. In an example embodiment the processor 60 associates the remote location to the local object.

It should be understood that the processor 60 may associate the remote location to the local object either before or after creation. In an embodiment, the processor 60 geo-tags the local object with the remote location.

In an embodiment, the wireless transceiver 12 communicates with the remote location source 117, such as a remote database, server, Bluetooth device, or the like, which is tracking location information for remote metadata. In an example embodiment, the remote location source 117 is a second electronic device, which the processor 60 recognizes the presence of the second electronic device. The processor 60, for example, may recognize a device from a Bluetooth device address stored as meta data in the object, facial recognition identifying a person in the object, e.g., known person with known device, ambient sound analysis identifying people speaking within a period of time from the object creation/capturing time, or the like. In operation, the transceiver 12 communicates, using a Bluetooth device address, for example, with the second electronic device and the processor 60 determines a location or geographic position at a time other than the creation time of the object. In an embodiment, the transceiver 12 may communicate with the second electronic device using a bluetooth device addresses or the like.

In another example embodiment, the remote location source is a remote database or server including published photographs. For example, the published photographs may include metadata, a set of Bluetooth address for nearby devices, and GPS information, e.g., coordinates, cell id, and country/city/street name. The processor 60 uses, for example, the Bluetooth address to identifying other objects captured in a similar time period/window as the object. The processor 60 may identify other objects by comparing a plurality of remote timestamps and device identifier, where the other objects are associated with a location to a local timestamp and device identifier. The processor 60 may also identify the location by matching the local timestamp and device identifier with a remote timestamp and remote device identifier associated with a location. The processor 60 may then associate the location with the local object.

In yet another embodiment, the processor 60 may use a service, which creates a user's location history log. One such service may be Nokia Sports Tracker. Nokia Sports Tracker, for example, is a GPS-based activity tracker that runs on electronic devices, such as electronic device 100. Information, such as speed, distance, location, e.g., GPS information/latitude, longitude, and a time period, are automatically stored in a history log. By accessing the history log, the processor 60 may determine a location for the object by comparing other items created with during the same time period and matching the object creation/capture time within the log time period. In an embodiment, the processor 60 obtains the location from the log history and geo-tags the object. It is useful to note that since the location comes from the log, the processor 60 may geo-tag objects for non-mobile devices, cameras, mobile cameras with or without GPS capabilities, and/or the like.

In an embodiment, the electronic device 100 and the remote location source 117 may communicate in a wireless network that may be a wireless personal area network (WPAN) operating, for example, under the Bluetooth or IEEE 802.15 network protocol. For example, the wireless network may be a wireless local area network (WLAN) operating, for example under the IEEE 802.11, Hiperlan, WiMedia Ultra Wide Band (UWB), WiMax, WiFi, Digital Enhanced Cordless Telecommunications (DECT) network protocol, and/or the like. Or, the wireless network may be a wireless wide area network (WWAN) operating, for example, under a cellular telephone network protocol, for example Global System for Mobile (GSM), General Packet Radio Service (GPRS), Enhanced Data rates for GSM Evolution (EDGE), Code Division Multiple Access (CDMA), Universal Mobile Telecommunications System (UMTS), CDMA2000, and/or the like. For example, the respective wireless network protocols include provision for communication by the electronic device 100 in the network with the location source by way of a Protocol Data unit (PDU) packet, such as Packets 120A-C of FIG. 1A. These examples of wireless network protocols for the electronic device 100 are not meant to be limiting, since it is common for wireless communications protocols to provide for communication between electronic devices and a wired network infrastructure.

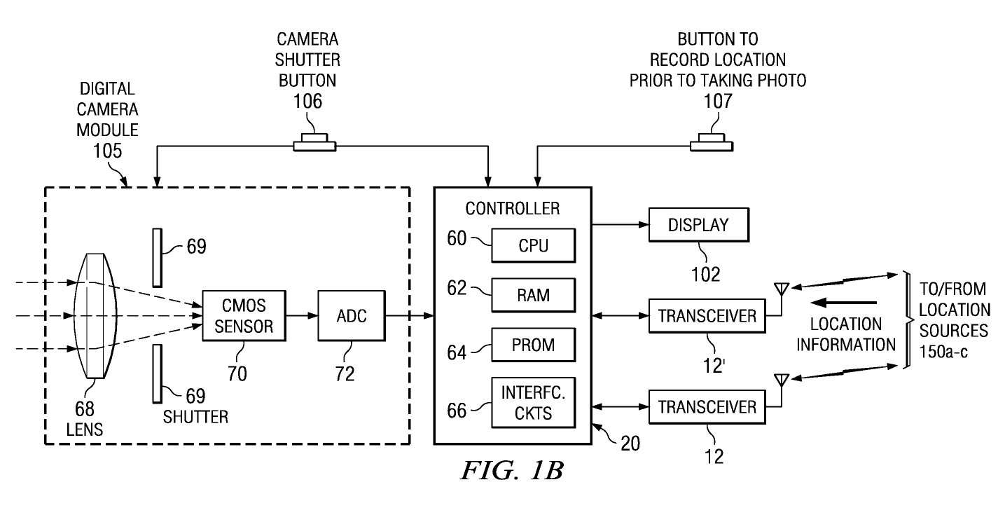

FIG. 2 is a flow diagram illustrating an example process 200 using a processor in an electronic device, such as the processor 60 of the electronic device 100 of FIG. 1A, to geo-tag an object after creation by applying rules according to an example embodiment of the invention. In particular, the processor creates an object, for example by taking a picture using a digital camera, recording a video, audio sequence, or the like. At 202 the processor is configured to create the object. At 204, the processor is configured to obtain a rule, comprising a time period or window and optionally a rate of motion. For example, a rule may define a two hour time period where the user was creating objects and traveling at the rate of motion of 3 km/hr. Alternatively, the user may choose to define a rate of motion, a time period, or neither.

In an embodiment, the processor may employ a processor, such as processor 60 of FIG. 1A. The processor 60 may apply rules to the location information and calculates relative GPS positions for an object at a time other than creation of the object. In an embodiment, a user may define rules for determining a location before or after creation of objects. When identifying the location for the object is desired, an electronic device or processor may use the defined rules to determine a location for an object. In an example embodiment, the user may define one or more bounding boxes with associated rules or filters for recording objects (videos, still images, voice clips).

For example, a bounding box may include of a pair of bounding GPS latitude/longitude coordinates, and a rule to apply. A bounding box may be in the form of: “from={latitude1, longitude1}, to={latitude2, longitude2}” has four corners: {latitude1, longitude1}, {latitude1, longitude2}, {latitude2, longitude1}, {latitude2, longitude2}. It should be noted that the shape of the bounding area is not restricted to a rectangle; it may be a pentagon, polygon, circle, or an area consisting of user's freely selected corners. A rectangle is merely an example and any other form of area may be used as well.

Such a bounding box with could, for example, be a user defined time period rule in the form of:

“from={latitude1, longitude1}, to={latitude2, longitude2}, <time period>: location is ‘<location information>’”, wherein <replacement string> is “Helsinki”, “Finland” and <time period> is “7:00 a.m. to 10:00 a.m.”

A second example could be a user defined dynamic time period rule in the form of:

“from={latitude1, longitude1}, to={latitude2, longitude2}, <time period>, <rate of motion>: location is ‘<location information>’”, wherein <replacement string> is “Helsinki”, “Finland” <time period> is “7:00 a.m. to 10:00 a.m.”, and <rate of motion> is “3 km/hr.”

It should be understood that example embodiments of the invention employ these rules by matching an object creation time with a timestamp in the time period or dynamic time period. It should be understood in the case of the dynamic time period, the rule allows the process 200 to calculation location information based on the movement of the user.

Referring back now to this example embodiment, the processor may obtain the rule at 204. At 210, the processor may connect to a location source to obtain location information of the object. The processor may obtain location information from the location source at 212. At 214, the processor using a processor 60 may apply rule(s), such as the rules described above, to the location information to determine a location. For example, the processor may compare a plurality of timestamps in rule defined a time period from the location source, associated with a location or local geographic position, to a local timestamp for the time period of the object. In an embodiment, the processor may identify a local geographic position, e.g., a location, by matching the local timestamp with a timestamp in the time period. For example, by comparing the object creation time with the time period, the processor may match a timestamp within the time period with the creation time of the object. As a result, the processor may obtain the corresponding location, e.g., latitude, longitude, for the matched time. The corresponding location may now be associated at 220 with the object. At 222, the processor may geo-tag the object with the location.

In one example embodiment, the time period is dynamic. In this example embodiment, the processor may apply a rate of motion, e.g., speed of the user's movement, of the user creating the object to create/adjust the locations in the dynamic time period. By applying the rate of motion, the processor may dynamically calculate speed and, in turn, a dynamic time period with corresponding location information based on the user's speed. In one embodiment, the processor may compare a creation time for the object with a dynamic time period created in view of the speed of the user. For example, the processor may compare the creation time with the dynamic time period and matches a time within the dynamic time period with the creation time. The processor may determine a location for the matched time of the object. In an embodiment, the processor may associate the location with the object.

It should be understood that speed is the rate of motion, or equivalently the rate of change in position, often expressed as distance “d” traveled per unit of time “t”. That is, speed is a scalar quantity with dimensions distance/time; the equivalent vector quantity to speed is known as velocity. In a mathematical notation, speed is represented as V=d/t where “v” is the variable for speed.

It should also be understood that associating may include embedding or tagging metadata in the object, or otherwise providing a unique association between the metadata and the object, e.g., by storing a pointer in the object pointing to the associated metadata.

It should be further understood that the process 200 provides an example of associating a location with a created object. Process 200, however, may also be employed before creation of the object, for example, when the shutter button is actuated.

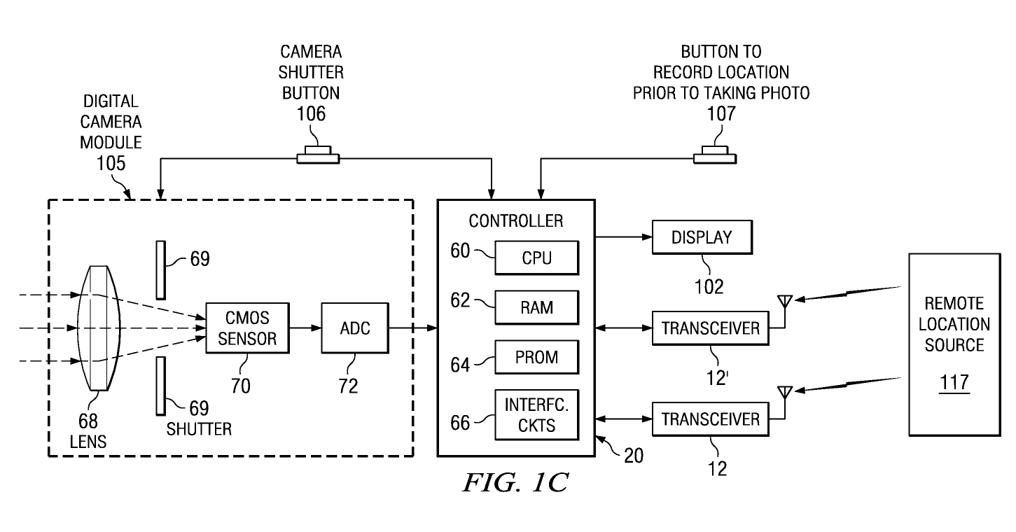

FIG. 3 is a flow diagram illustrating an example process 300 for associating a location with an object after creation according to an example embodiment of the invention. In particular, the example process 300 begins after a user creates an object by pressing the camera shutter 106 of FIG. 1A or otherwise creates the object. In an embodiment, a processor in an electronic device, such as processor 60 of the electronic device 100 of FIG. 1A, may communicate with a location source to obtain location information, after creation, of the object at 305. For example, the user is exploring a museum, such as Neue Pinakothek in Munich. The user has stopped near a point of interest, the still life by Vincent van Gogh, “Sunflowers”, and has taken a photograph, e.g., creation of an object, and the processor may communicate with a location source comprising location information. In an embodiment, the processor may determine a location of an object based on the location information, using a dynamic time period, at a time other than creation of the object at 310. In one example, the processor may apply a rule to compare and match time of the object creation and a dynamic time period of a location source. At 315, the processor may associate the determined location with the object. In an embodiment, the process 300 may geo-tag the object as desired. It should be understood that the location information may be provided by the packets 120A, 120B, and 120C obtained by the processor 60 in FIG. 1A.

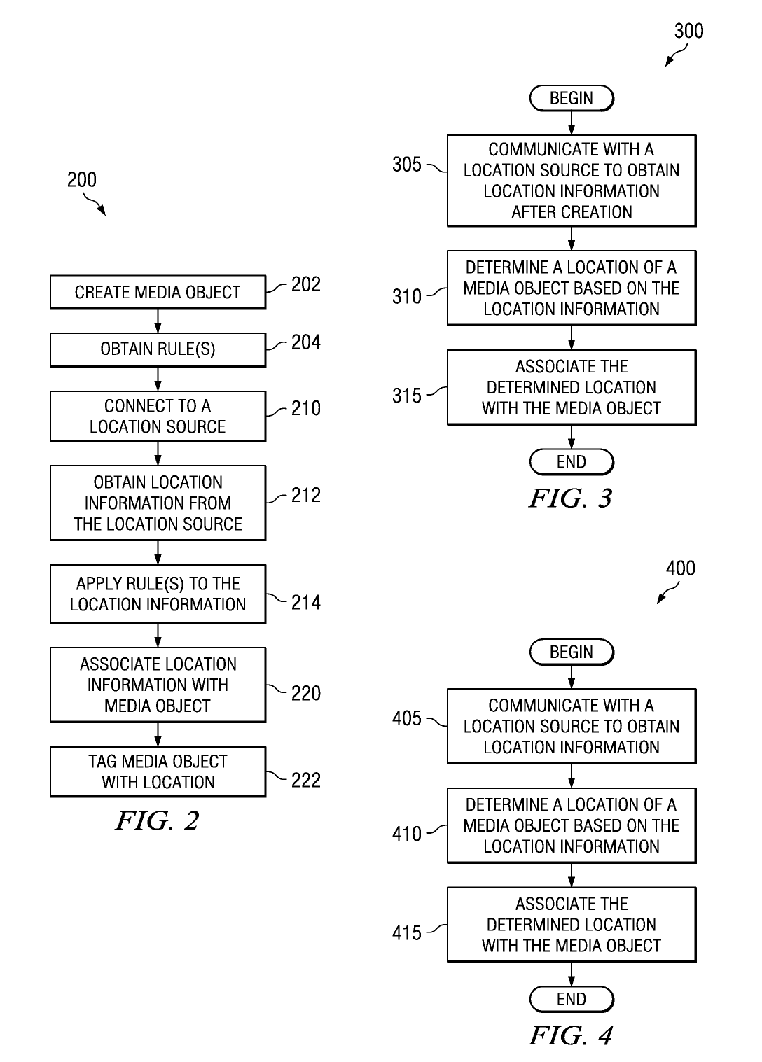

FIG. 4 is a flow diagram illustrating an example process 400 for associating a location with an object before creation according to an example embodiment of the invention. For example, a photographer anticipates taking a photograph at a particular location and sets up the camera before taking the picture. By pressing the shutter button 106 on the electronic device 100 of FIG. 1B, the example process 400 begins. In an embodiment, a processor, such as processor 60 of FIG. 1B, may communicate with a location source to obtain location information before creation at 405. The processor may determine the location (as described above) for the object at 410. At 415, the processor 60 may associate the location with the object before creation, e.g., as part of creation setup. As a result, the processor may geo-tag an object file, before creation of the object. In this way, the processor tags an object before creation.

In an alternative embodiment, the processor may associate a location with an object after creation according to an example embodiment of the invention. In particular, the example process 400 begins at a time in post creation of the object. For example, a user may have returned home from exploring a museum or a week long holiday. In operation, the processor may communicate with a remote or local location source to obtain location information associated with the object at 405. In an embodiment, the location information may include a device identifier, a time, and/or a location. Using the location information, the processor may determine a location of an object, as described above, at 410. In one example, the processor may determine the location by applying a rule to compare and match the time and/or device identifier of the object to the time and/or device identifier information in the location information. At 415, the processor may associate the location with the object. In an embodiment, the processor may geo-tag the object as desired.

In an example embodiment, the calculated absolute or estimated position of the electronic device 100 may be stored in a file or database separate from, but associated with, the stored object, in the object of the electronic device and the geo-tagging of the photograph may be performed later. In an example embodiment, the geo-tagging of the photograph may be performed off-line, when the user uploads the object and the calculated absolute or estimated position of the electronic device 100 to a personal computer or to a server on the Internet, such as for creating a web album.

In an example embodiment, the object and the location may be stored in a variety of media, for example a random access memory (RAM), a programmable read only memory (PROM), a magnetic recording medium such as a video tape, an optical recording medium such as a writeable CDROM or DVD.

The above discussion has been directed in part to the electronic device 100 performing digital photography. Other example embodiments may use the same techniques to geo-tag other objects such as short message service (SMS) messages, multimedia messages, or other phone messages. For example, when a recipient receives a phone call or SMS message, a processor may geo-tag the call or SMS message before or after the call or message originates. Also, for example, personal notes stored in electronic device 100 may be geo-tagged in a similar fashion. It should be further understood that the electronic device 100 is merely an example device and other devices, such as a touch screen, mobile phone, and/or the like may also perform example embodiments of the invention. For example, the electronic device 100 is not limited to the user of a button, but rather may also comprise devices without buttons or a combination thereof.

Without in any way limiting the scope, interpretation, or application of the claims appearing below, it is possible that a technical effect of one or more of the example embodiments disclosed herein may be geo-tagging meta data for objects created by an electronic device without GPS capability. Another possible technical effect of one or more of the example embodiments disclosed herein may be geo-tagging meta data for objects created by an electronic device at a time other than creation.

Embodiments of the present invention may be implemented in software, hardware, application logic or a combination of software, hardware and application logic. The software, application logic and/or hardware may reside on a mobile phone, personal digital assistant or other electronic device. If desired, part of the software, application logic and/or hardware may reside on a chip and part of the software, application logic and/or hardware may reside on a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is

1. A method, comprising:
communicating with a location source to obtain location information;
determining a location of an object at a time other than creation of the object based on the location information; and
associating the determined location with the object.

2. The method of claim 1 wherein the location source is on the same network platform as the object.

3. The method of claim 1 wherein the location source is in a remote location.

4. The method of claim 1 wherein the location information comprises at least one of the following listed items: at least one timestamp; metadata; a device identifier.

5. The method of claim 1 wherein determining a location further comprises applying a rule to the location information.

6. The method of claim 1 wherein determining a location further comprises using a dynamic time period.

7. The method of claim 6 further comprising:
applying a rate of motion rule to determine the dynamic time period.

8. The method of claim 1 wherein determining a location further comprises:
communicating with an electronic device; and
obtaining the location from the electronic device.

9. The method of claim 1 wherein determining a location further comprises:
communicating with a service; and
obtaining the location from the service.

10. The method of claim 1 wherein determining a location further comprises:
communicating with an Internet application; and
obtaining the location from the Internet application.

11. The method of claim 1 wherein determining a location further comprises:
comparing a plurality of remote timestamps, associated with the location and remote metadata, to a local timestamp and local metadata;
matching the local timestamp and local metadata and at least one remote timestamp and remote metadata; and
identifying the location.

12. The method of claim 1 wherein associating the determined location with the object further comprises:
tagging the object with meta data.

13. The method of claim 12 wherein tagging the object is geo-tagging.

14. The method of claim 1 wherein the object is a video; audio file; Short Message Service; other data object.

15. An apparatus, comprising:
a wireless transceiver configured for communication with a location source to obtain location information; and
a processor configured for:
determination of a location for an object at a time other than creation of the object based on the location information; and
association of the determined location with the object.

16. The apparatus of claim 15 wherein the location source is on the same network platform as the object.

17. The apparatus of claim 15 wherein the location source is in a remote location.

18. The apparatus of claim 15 wherein the location information comprises at least one of the following listed items: at least one timestamp; metadata; a device identifier.

19. The apparatus of claim 15 wherein the processor is further configured for application of a rule to the location information to determine the location.

20. The apparatus of claim 15 wherein determination of a location uses a dynamic time period.

21. The apparatus of claim 15 wherein the processor is further configured for:
application of a rate of motion rule to determine the dynamic time period.

22. The apparatus of claim 15 wherein the determination of a location further comprises:
the wireless transceiver further configured for communication with an electronic device; and
the processor further configured for determination of the location from the electronic device.

23. The apparatus of claim 15 wherein the determination of a location further comprises:
the wireless transceiver further configured for communication with a service; and
the processor further configured for determination of the location from the service.

24. The apparatus of claim 15 wherein the determination of a location further comprises:
the wireless transceiver further configured for communication with an Internet application; and
the processor further configured for determination of the location from the Internet application.

25. The apparatus of claim 15 wherein the processor is further configured for:
comparison of a plurality of remote timestamps, associated with the location and remote meta data, to a local timestamp and local metadata;
match the local timestamp and local metadata and at least one remote timestamp and remote metadata; and
identification of the location.

26. The apparatus of claim 15 wherein the processor in association of the determined location is further configured for:
tagging the object with meta data.

27. The apparatus of claim 26 wherein tagging the object is geo-tagging.

28. The apparatus of claim 15 wherein the object is a video; audio file; Short Message Service; other data object.

29. A computer program product comprising a computer-readable medium bearing computer program code embodied therein for use with a computer, the computer program code comprising:
code for communicating with a location source to obtain location information;
code for determining a location of an object at a time other than creation of the object based on the location information; and
code for associating the determined location with the object.

30. A computer-readable medium encoded with instructions that, when executed by a computer, perform:
communicating with a location source to obtain location information;
determining a location of an object at a time other than creation of the object based on the location information; and
associating the determined location with the object.
